(19) United States
(12) Patent Application Publication
(10) Pub. No.: US 2021/0347575 A1
(43) Pub. Date: Nov. 11, 2021

(54) TRANSPORT CARRIAGE AND TRANSPORT SYSTEM FOR TRANSPORTING OBJECTS

(71) Applicant: pentanova cs GmbH, Böblingen (DE)

(72) Inventors: Mario Lutz, Schönaich (DE); Martin Wäder, Weil im Schönbuch (DE); Harry Dreger, Weil im Schönbuch (DE); Marc Walter Kirchner, Bammental (DE)

(21) Appl. No.: 17/314,139

(22) Filed: May 7, 2021

(30) Foreign Application Priority Data
May 7, 2020 (DE) 10 2020 112 397.3

(51) Int. Cl. B65G 17/06

(52) U.S. Cl. CPC B65G 17/068

(57) ABSTRACT

A transport carriage for transporting objects comprises a chassis which defines a main axis of the transport carriage and is configured to run on a rail system having a first rail and a second rail parallel thereto, and has a first chassis unit for the first rail and a second chassis unit for the second rail and a transport structure for at least one object, the transport structure defining a transport plane. The first chassis unit is coupled to the transport structure in a rotationally fixed manner such that the first chassis unit cannot be tilted relative to the transport plane in the direction of the main axis. The second chassis unit is coupled to the transport structure in a rotatable manner such that the second chassis unit can be tilted relative to the transport plane in the direction of the main axis about a tilt axis.

### RELATED APPLICATIONS

The present application claims priority to German Application No. 10 2020 112 397.3 filed May 7, 2021—the contents of which are fully incorporated herein by reference.

### BACKGROUND OF THE INVENTION

### 1. Field of the Invention

The invention relates to a transport carriage for transporting objects having
a) a chassis which defines a main axis of the transport carriage and is configured to run on a rail system having a first rail and a second rail parallel thereto, and comprises a first chassis unit for the first rail and a second chassis unit for the second rail;
b) a transport structure for at least one object, the transport structure defining a transport plane.

In addition, the invention relates to a transport system for transporting objects comprising a rail system having a first rail and a second rail parallel thereto, and a plurality of transport carriages traveling on the rail system.

The term two parallel rails is to be presently understood such that both rails define a path which the transport carriage or the chassis, respectively, follows. Depending on the construction concepts of the conveyor technology, the two rails can extend mathematically parallel or deviate zo from such mathematical parallelism. Construction tolerances that lead to a deviation from such mathematical parallelism are also included herein.

### 2. Description of the Prior Art

Such transport carriages and transport systems are usually conceived as electric floor conveyors and are used, for example, in logistics centers to move goods. Articles may be received, as objects, directly by the transport structure. Alternatively, articles may be accommodated on separate conveyor structures, for example a pallet or the like, which may then be carried by the transport carriage. Depending on the work area, loads of up to two tons can be positioned on a transport carriage. The transport carriages can reach high speeds of up to 180 m min⁻¹.

Accordingly, relatively high dynamic forces can occur on the components during operation and the transport system as such must be able to absorb corresponding forces.

The transport carriages run on load-bearing support rollers or support wheels, respectively, on the upper running surfaces of the rails, one or more of which are usually driven and which both drive and decelerate the transport carriage. Often, only one of the load-bearing rollers is a drive roller, which is responsible for propelling and decelerating the transport carriage. In the following, only the term roller will be used, which is, however, merely representative of all types of corresponding running means.

For smooth transport, it is therefore important that in particular the one or more drive rollers always run with as full contact as possible on the running surfaces so that there is no reduction or even loss of drive or braking forces. This can occur in particular due to elastic deformations caused by static and/or dynamic force effects both on the rail system and on the transport carriage.

Since the contact of the support rollers is determined by the roller load distributed to a respective support roller, it is consequently desirable that this roller load be maintained uniformly as the transport carriage moves. In particular, if a roller other than the drive roller passes through a depression or elevation, the contact of the drive roller with the rail may decrease to an undesirable degree.

Until now, this has been counteracted by implementing the stiffest possible construction for both the rail system and the transport carriages. However, this usually requires large masses, which on the one hand increases material requirements and thus costs, and on the other hand also leads to large moving masses and the resulting loads and dynamic losses that prevent agile operation.

### SUMMARY OF THE INVENTION

It is an object of the present invention to provide transport carriages and a transport system of the type mentioned at the beginning which take these thoughts into account.

This object is solved in the case of a transport carriage of the type mentioned at the beginning in that
d) the first chassis unit is coupled to the transport structure in a rotationally fixed manner such that the first chassis unit cannot be tilted relative to the transport plane in the direction of the main axis;
e) the second chassis unit is coupled to the transport structure in a rotatable manner such that the second chassis unit can be tilted relative to the transport plane in the direction of the main axis about a tilt axis.

Tilting in the direction of the main axis is to be understood such that a defined point of the chassis moves with a movement component in the direction of the main axis during tilting.

This measure achieves that the load of the transport carriage is distributed evenly over the present support rollers, on the one hand, and that the contact of the present support rollers and in particular the drive roller(s) is well maintained.

It is thereby advantageous if the tilt axis extends parallel to the support plane and perpendicular to the main axis.

In one embodiment, the second chassis unit is configured as a mono-roller chassis unit with a single load-bearing individual support roller, wherein
a) the individual support roller has an axis of rotation which extends coaxially with the tilt axis; and/or
b) the individual support roller is supported by a bearing frame.

Advantageously, the individual support roller is rotatable about a steering axis so that cornering is possible without relative transverse positioning of the individual support roller, which reduces wear.

A better load distribution can be achieved if the second chassis unit is configured as a multi-roller chassis unit with at least a first load-bearing support roller and a second load-bearing support roller.

Advantageously, the first support roller is arranged leading in front of the tilt axis and the second support roller is arranged trailing behind the tilt axis, viewed in the direction of the main axis.

Advantageously from a construction point of view, the first support roller is mounted in or on a first support unit and the second support roller is mounted in or on a second support unit, which are connected to one another by a connecting structure, which in turn is connected to the bearing structure such that it can tilt about the tilting axis.

In order to, in particular, compensate changes in the distance between the rails in curved sections in the rail system, it is advantageous if a compensating device is provided, which enables displacement of at least one load-bearing support roller in the direction transverse to the main axis.

For this purpose, the compensating device preferably has at least one bearing swing arm on at least one chassis unit, wherein the bearing swing arm is mounted such that the bearing swing arm is pivotal about a swinging axis and carries a support unit for a support roller.

Preferably, the compensating device comprises a first bearing swing arm for the first support unit of the second chassis unit and a second bearing swing arm for the second support unit of the second chassis unit.

It is also advantageous if a pivoting device is provided, by means of which the support rollers provided on the first chassis unit and/or the support rollers provided on the second chassis unit can each be pivoted relative to the transport structure about a pivot axis which extends in a vertical plane parallel to the main axis and a plane parallel to the transport plane.

Twisting of the transport carriage, which can occur when one of the chassis units travels through a depression or elevation, for example in the case of an unevenness in the track, can thereby be counteracted.

Preferably, the transport carriage comprises a dampening system by means of which a rotation or a pivoting of components relative to each other on one or more of the tilt axis, the swinging axes and the pivot axes, if the respective axis is provided, dampens. The transport carriage can thereby run more smoothly overall.

The above-identified object is also solved in the case of a transport system of the type mentioned at the beginning in that the transport carriages are configured with some or all of the features described above.

Other advantages and aspects of the present invention will become apparent upon reading the following description of the drawings and detailed description of the invention.

### BRIEF DESCRIPTION OF THE DRAWINGS

In the following, embodiments of the invention are explained in more detail with reference to the drawings.

FIG. 1 shows a first embodiment of a transport carriage for transporting objects with a chassis and a transport structure, wherein a first chassis unit and a second chassis unit are coupled to the transport structure and the second chassis unit is a mono-roller chassis unit;

FIG. 2 shows a second embodiment of a transport carriage with a modified second chassis unit;

FIG. 3 shows a third embodiment of the transport carriage in which the second chassis unit is a multi-roller chassis unit;

FIG. 4 shows a fourth embodiment of the transport carriage in the region of a curve;

FIG. 5 shows a fifth embodiment of the transport carriage.

### DETAILED DESCRIPTION OF THE INVENTION

While this invention is susceptible to embodiments in many different forms, there is described in detail herein, preferred embodiments of the invention with the understanding that the present disclosures are to be considered as exemplifications of the principles of the invention and are not intended to limit the broad aspects of the invention to the embodiments illustrated.

In the figures, 10 generally refers to a transport carriage for transporting objects, the objects not being specifically shown.

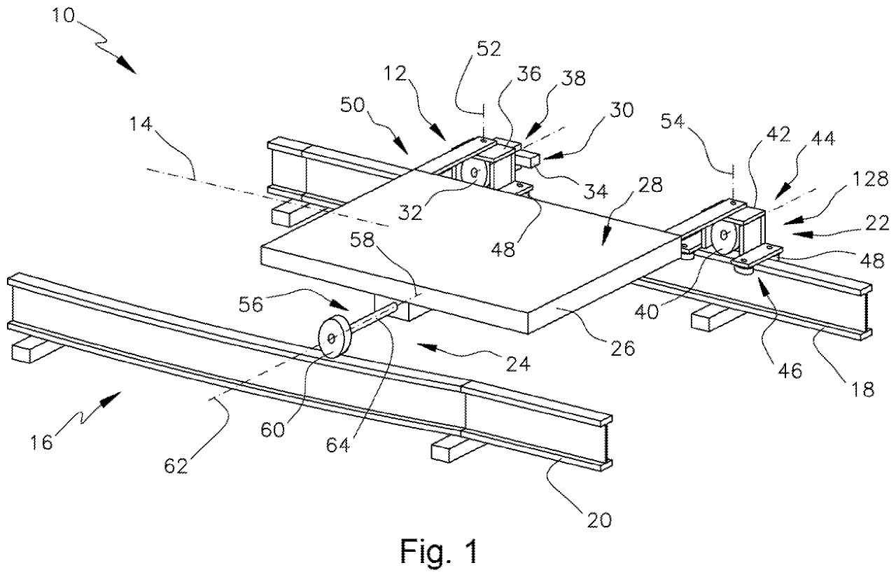

The transport carriage 10 includes a chassis 12 defining a main axis 14 of the transport carriage 10 illustrated by a dash-dotted line, shown only in FIG. 1. In the present embodiments, the main axis 14 is the longitudinal axis of the transport carriage 10.

The chassis 12 is configured to run on a rail system 16 having a first rail 18 and a second rail 20 parallel thereto. For this purpose, the chassis 12 comprises a first chassis unit 22 for the first rail 18 and a second chassis unit 24 for the second rail 20.

The transport carriage 10 further comprises a transport structure 26 for at least one object, wherein the transport structure 26 defines a transport plane 28 and is mounted on the chassis 12 and, for this purpose, on the first chassis unit 22 and the second chassis unit 24. The transport plane 28 and an object attached to or received by the transport structure 26 move with the support structure 26.

In the figures, the transport structure 26 is schematically shown as a type of support floor. However, the transport structure 26 may be configured in any form suitable for receiving one or more objects, and may also be specially adapted to objects to be transported. In this regard, the transport structure 26 is often in turn configured as a conveyor device and may be, for example, a roller conveyor or a chain conveyor and may receive and deliver the objects transversely to the main axis 14. The transport structure 26 may be configured to receive a Euro pallet or may be conceived as a carrying basket for small items. In the case of a carrying basket, the transport plane 28 may be defined by its floor, for example. In practice, the transport plane 28 also extends horizontally in a normal operating orientation of the transport carriage 10 on a horizontal path.

The transport carriage 10 comprises a drive system 30 with at least one drive roller 32, which can be driven by means of a drive motor 34. The drive system 30 is supplied with energy in a manner known per se by a conductor line, an induction system, a capacitor system or an accumulator, which are not shown specifically.

The drive roller 32 and its drive motor 34 are mounted on a drive frame 36 of a drive unit 38. In the present embodiments, the drive unit 38 is comprised by the first chassis unit 22, but may also be supported by the second chassis unit 24. In addition, the first chassis unit 22 includes a support roller 40, which passively travels along and is mounted on a support frame 42 of a support unit 44. The drive roller 32 and the support roller 40 run on a running surface on the upper side of the first rail 18, wherein both the drive roller 32 and the support roller 40 are the load-bearing support rollers in the case of the first chassis unit 22. The axes of rotation of the drive roller 32 and the support roller 40 are shown in dash-dotted lines, but do not bear a separate reference sign.

In order to prevent the drive unit 38 and the support unit 44 or the first chassis unit 22 of the transport carriage 10, respectively, from tilting in the transport direction or transversely to the transport direction, a support system 46 with support rollers 48 is provided which abut the first rail 18 and prevent such tilting in a manner known in and of itself.

In a variation not specifically shown, the drive roller 32 may also engage laterally with the first rail 18. In this case, instead of the drive roller, the drive unit 38 is provided with a support roller, which passively travels along and which runs on top of the running surface on the upper side of the first rail 18 and then bears the load. Regardless of the arrangement of the drive roller 32, one or more supplementary load-bearing rollers may still be provided.

The first chassis unit 22 is coupled to the transport structure 26 by means of a first coupling device 50.

The transport carriage 10 is generally capable of cornering. For this purpose, the drive roller 32 and the support roller 40 are rotatable relative to the coupling device 50 about a respective steering axis 52 and 54, respectively, which extend in a respective vertical plane. In the present embodiments, the drive frame 36 is mounted on the coupling device 50 so as to be rotatable zo about the steering axis 52 and the support frame 42 is mounted so as to be rotatable about the steering axis 54 and can thus follow the course of the rail.

In the figures, the first coupling device 50 is only exemplarily and schematically illustrated by one connecting bar, respectively between the transport structure 26 and the drive unit 38 or the support unit 44, respectively, which do not have a separate reference sign.

The first chassis unit 22 is coupled to the transport structure 26 in a rotationally fixed manner such that the first chassis unit 22 cannot be tilted relative to the transport plane 28 in the direction of the main axis 14. Tilting in the direction of the main axis means that the ends of the first chassis unit 22 facing in the direction of the main axis 14 move with opposite movement components in the vertical direction relative to the transport structure 26 during such tilting.

The second chassis unit 24 is coupled to the transport structure 26 by a second coupling device 56.

In contrast to the first chassis unit 22, however, the second chassis unit 24 is rotatably coupled to the transport structure 26 such that the second chassis unit 24 can be tilted relative to the transport plane 28 in the direction of the main axis. This means that the second chassis unit 24 can be tilted relative to the transport plane 28 about a tilt axis 58, wherein the ends of the second chassis unit 24 facing in the direction of the main axis 14 move with opposite movement components in the vertical direction relative to the transport structure 26 during such tilting.

In the present embodiments, the tilt axis 58 extends parallel to the transport plane 28, i.e., the tilt axis 58 extends at an angle of 0° to the transport plane 28. However, in variations not specifically shown, the tilt axis 58 may also extend at an angle greater than 0° and less than 90° to the transport plane. Furthermore, in the present embodiments, the tilt axis 58 extends perpendicularly and thus at an angle of 90° to the main axis 14. In variations not specifically shown, however, the tilt axis 58 may also extend at an angle smaller than 90° and larger than 0° to the main axis 14.

In the embodiment of the transport carriage 10 shown in FIG. 1, the second chassis unit 24 is configured as a mono-roller chassis unit and in this case by a single load-bearing individual support roller 60, which runs on the running surface on the upper side of the second rail 20 and is mounted on the transport structure 26 by means of the second coupling device 56 such that the support roller 60 is rotatable about an axis of rotation 62.

In the present embodiment, the tilt axis 58 and the axis of rotation 62 of the individual support roller 60 extend coaxially. For this purpose, the second coupling device 56 is configured as a stub axle 64, which is attached to the transport structure 26 at one end and rotatably supports the individual support roller 60 at the other end. However, a corresponding arrangement of the tilting axis 58 and the axis of rotation 62 may also be achieved with the aid of differently configured coupling devices.

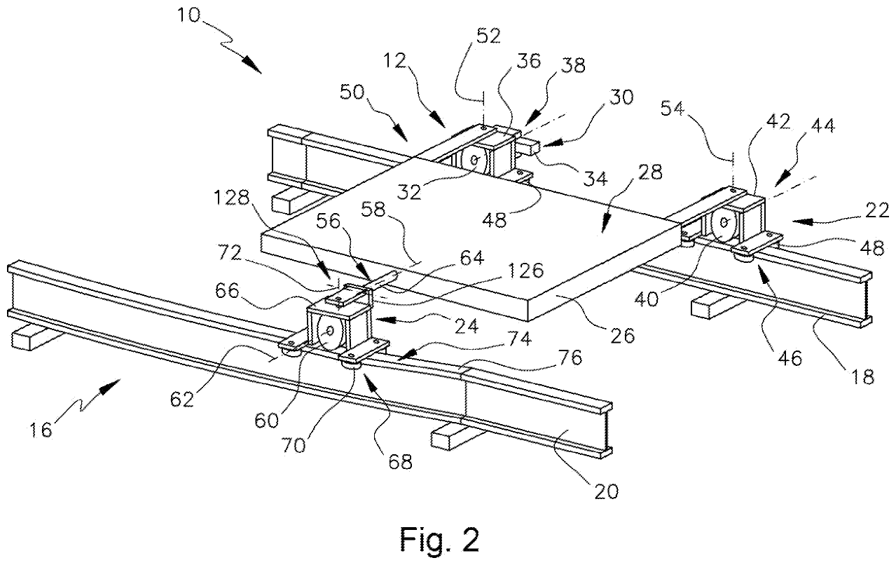

In the embodiment according to FIG. 2, the second chassis unit 24 is also configured as a mono-roller chassis unit, but additionally comprises a bearing frame 66 which supports the individual support roller 60. The bearing frame 66 is in turn connected to the bearing structure 26 via the second coupling device 56 such that the bearing frame 66, and thus the second chassis unit 24, can be tilted about the tilt axis 58 relative to the transport plane 28 in the manner described. For this purpose, the bearing structure 26 may be connected rotatably to the second coupling device 56, which in turn engages non-rotatably with the transport structure 26.

Alternatively, the bearing structure 26 may also be non-rotatably connected to the second coupling device 56 if it is in turn attached to the transport structure 26 such that it is rotatable about the tilt axis 58. Still alternatively, the coupling device 56 may also comprise two parts connected to each other such that they are rotatable about the tilt axis 58, one of which parts is non-rotatably connected to the bearing structure 66 and the other of which is non-rotatably connected to the transport structure 26.

The tilt axis 58 thereby extends parallel to, but no longer coaxially with, the axis of rotation 62 of the individual support roller 60. Specifically, the tilt axis 58 on the second chassis unit 24 is offset in an upward direction with respect to the axis of rotation 62 of the individual support roller 60. However, a coaxial arrangement of the axes 58 and 62 is readily possible.

The second chassis unit 24 comprises a support system 68 with support rollers 70, which prevents the second chassis unit 24, i.e. here the bearing frame 66, from tilting in the transport direction or transversely to the transport direction, as is ensured in the first chassis unit 22 by the support system 46.

The individual support roller 60 is supported by the bearing frame 66 such that the individual support roller 60 may also rotate about a steering axis 72, which again extends in a vertical plane. For this purpose, the bearing frame 66 is mounted on the second coupling device 56 so as to be rotatable about the steering axis 72.

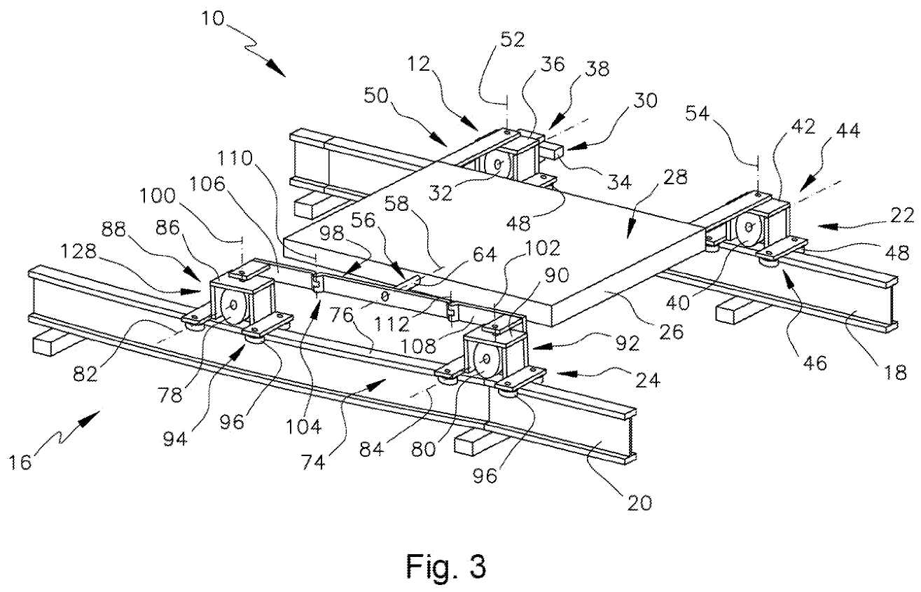

In FIGS. 1 and 2, as well as in FIGS. 3 to 5 explained further below, an unevenness 74 is illustrated in the second rail 20, as can occur, for example, due to structural tolerances or due to damage during operation. Here, however, the unevenness 74 is highly exaggeratedly illustrated to an extent that should not occur in practice. In the following, the unevenness 74 is described using the example of a lowering with a decline section 76 in the direction of the main axis 14. What has been said in this context applies generally to a slope section, i.e., also to an incline section, mutatis mutandis.

The ability of the second chassis 24 to tilt relative to the transport structure 26 allows the second chassis 24 to travel through and travel over the unevenness 74 without causing excessive displacement of the transport structure 26 and thus the transport plane 28. In particular, tilting of the transport structure 26 and the transport plane 28 in the direction of the main axis 14 is largely prevented.

The orientation of the transport structure 26 in the direction of the main axis 14 is predetermined by the orientation of the first chassis unit 24. The second chassis unit 26 can independently tilt about the tilt axis 58 without this having any effect on the transport structure 26. In this way, twisting of the transport carriage 10 as such is also prevented, which can lead to stress and material fatigue of the components involved and in particular of the joints between components involved over the operating period.

Thus, by way of example, when the second chassis unit 24 comes to the unevenness 74 and initially enters a decline section 76, the bearing frame 66 and thus the second chassis unit 24 can tilt forward about the tilt axis 58 in the direction of the main axis 14 and in the transport direction, the transport structure 26 remaining stabilized by the first chassis unit 24. Only in the direction transverse to the main axis 14 is there a lateral tilt of the transport structure 26, since the second chassis unit 24 on the second rail 20 is lowered relative to the first chassis unit 22 on the first rail 18 in the region of the unevenness 72.

This effect does not occur when the unevenness 74 occurs at the first rail 18. In this case, the first chassis unit 22 tilts downward in the direction of the main axis 14 when the drive unit 38 enters the decline section 76. The transport structure 26 thereby follows this tilting in the direction of the main axis 14 and is lowered at the same time on the side of the first chassis unit 22.

However, in the embodiments shown in FIGS. 1 and 2, there is a different distribution of force in the transport carriage 10 on both chassis units 22, 24 or on their existing load-bearing rollers 32, 40 and 60.

FIGS. 3 to 5 show embodiments of the transport carriage 10 in which the concept of the tilt axis 58 explained above remains realized and, in addition, a better weight distribution or force distribution can be achieved. In these cases, the tilt axis 58 primarily ensures that the existing load-bearing rollers always rest securely and, in particular, over their entire surface on the rails 18, 20.

FIG. 3 shows an embodiment in which the second chassis unit 24 is not configured as a mono-roller chassis unit with an individual support roller, but as a multi-roller chassis unit with several support rollers. In the embodiment shown here, there is a first load-bearing support roller 78 and a second load-bearing support roller 80, each of which rotates about an axis of rotation 82 and 84, respectively, on the running surface on the upper side of the second rail 20. Viewed in the direction of the main axis 14, the first load-bearing support roller 78 is arranged leading in front of the tilt axis 58 and the second load-bearing support roller 80 is arranged trailing behind the tilt axis 58. The first support roller 78 is mounted on a support frame 86 of a first support unit 88 and the second support roller 80 is mounted on a support frame 90 of a second support unit 92.

A support system 94 with support rollers 96 is also provided for the second chassis unit 24, by means of which tilting of the two support units 88, 92 or of the second chassis unit 24 of the transport carriage 10 in the transport direction or transversely to the transport direction is prevented.

In addition, the second chassis 24 includes a connecting structure 98 that connects the first and second support units 88 and 92. In the present embodiment, the connecting structure 98 is schematically illustrated as a connecting profile.

The first support roller 78 and the second support roller 80 are rotatable relative to the second coupling device 56 about a respective steering axis 100 and 102, which extend in a respective vertical plane. In the present embodiments, the two support frames 86 and 90 are mounted on the second coupling device 56 so as to be rotatable about the steering axis 100 and 102, respectively, and can thus follow the course of the rail.

The connecting structure 98 is connected to the transport structure 26 via the second coupling device 56 so as to be tiltable about the tilt axis 58, the tilt axis 58 being arranged centrally between the axes of rotation 82 and 84 of the support rollers 78 and 80 in the direction of the main axis 14. In variations not specifically shown, the tilt axis 58 may also extend eccentrically between the axes of rotation 82 and 84.

Thus, when the transport carriage 10 enters the region of unevenness 72 of the second rail 20, the leading first support unit 88 initially lowers into the decline section 76, while the trailing second zo support unit 92, in contrast, is still elevated on the correspondingly higher section of the second rail 20. However, both support rollers 78, 80 of the second chassis unit 24 remain fully in contact with the second rail 20; likewise, the drive roller 32 and the support roller 40 of the first chassis unit 22 remain in contact with the first rail 18.

When the unevenness 72 occurs on the second rail 20 on which the tiltable chassis unit 24 is located, the transport structure 26 remains aligned unchanged with respect to a horizontal plane because it is coupled to the first chassis unit 22 on the first rail 18 in a correspondingly rotationally fixed manner. Here, too, there is only a lateral inclination in the direction transverse to the main axis 14, since the second chassis unit 24 on the second rail 20 is lowered relative to the first chassis unit 22 on the first rail 18 in the region of the unevenness 72.

When a corresponding unevenness 74 occurs on the first rail 18, the transport structure 26 again follows the slope and height of the first chassis unit 22 in the direction of the main axis 14, as explained with respect to FIGS. 1 and 2. However, the rollers 32, 40, 78 and 80 remain in contact with the rail 18 or 20 at all times.

In practice, both rails 18 and 20 do not run strictly parallel; rather, the distance between the rails already varies due to structural tolerances. If the two chassis units 22 and 24 are guided by the support rollers 48 and 96 respectively on the rails 18, 20 in such a way that no freedom of movement in the direction transverse to the rails 18, 20 is possible, a change in the distance between the rails 18, 20 could result in heavy loads on the chassis units 22, 24 and the entire transport carriage 10.

In order to prevent this, a compensating device 104 is provided, which enables displacement of at least one of the load-bearing support rollers 32, 40, 60, 78 and/or 80 in a direction transverse to the main axis 14 relative to the transport structure 26.

In the present embodiment, for this purpose, the connecting structure 98 comprises a first bearing swing arm 106 and a second bearing swing arm 108, each of which is pivotally mounted about an upwardly facing swinging axis 110 and 112, respectively, and supports the first support unit 88 and the second support unit 92, respectively.

When the distance between rails 18 and 20 varies, the distance between two rollers adjacent in the direction transverse to the rails may also vary accordingly as the bearing swing arm 106 or 108 pivots laterally away from or toward the transport structure 26.

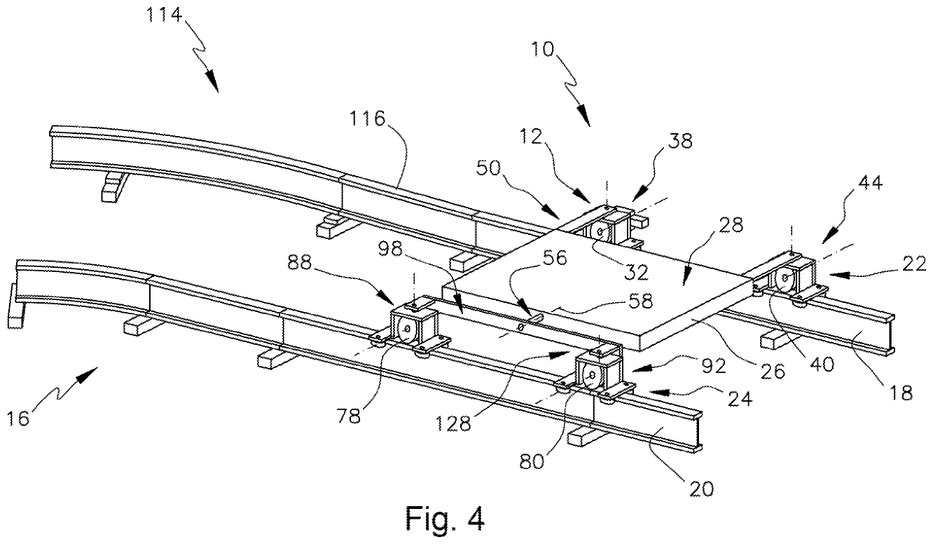

FIG. 4 shows another embodiment of the second chassis unit 24 in which there is no compensating device 104. This can also be practicable in individual cases. There, the connecting structure 98 is configured to be correspondingly rigid. In FIG. 4, not all components are marked with reference signs for the sake of simplicity.

However, FIG. 4 also illustrates that a decline section or an incline section in only one of the two rails 18 and 20 can also be a desired structural measure.

This is illustrated by the example of a curve 114 of the rail system 16, which is formed as a kind of steep curve and in which the radially outer rail, in this case the first rail 18, is elevated relative to the radially inner rail, in this case the second rail 20. Such a steep curve can generally be traversed more quickly by a transport carriage 10 loaded with an object than a curve in which both rails 18 and 20 are at the same height level.

In this case, the curve 114 is conceived such that the running surfaces on the upper sides of the rails 18 and 20 are oriented horizontally. In an alternative, the upper sides of the rails 18 and 20 may also be inclined towards each other in a cross-section. In the case of the rail 18, there is an incline section 116 prior the curve 114 which is necessary to guide the running surface on the upper side of the first rail 18 upwards to the curve 114.

Thus, when the transport carriage 10 now arrives at the curve 114, the first chassis unit 22 passes through the incline section 116. The second chassis unit 24 on the opposite second rail 20 thereby tilts relative to the transport structure 26 about the tilt axis 58, as explained above. As a result, all rollers 32, 40, 78 and 80 involved remain in good contact with their respective rail 18 or 20 even in the incline section 116.

As described above in each case, lateral tilting of the transport structure 26 occurs when there is a slope section, i.e., a decline section or an incline section, in one of the two rails 18, 20. In this case, the overall structure of the transport carriage 10 comprising the two chassis units 22, 24, the transport structure 26 and the two coupling devices 50, 56 twists. In particular, the loads are significant at the connection points between the coupling devices 50 and 56 to the chassis units 22 and 24, respectively.

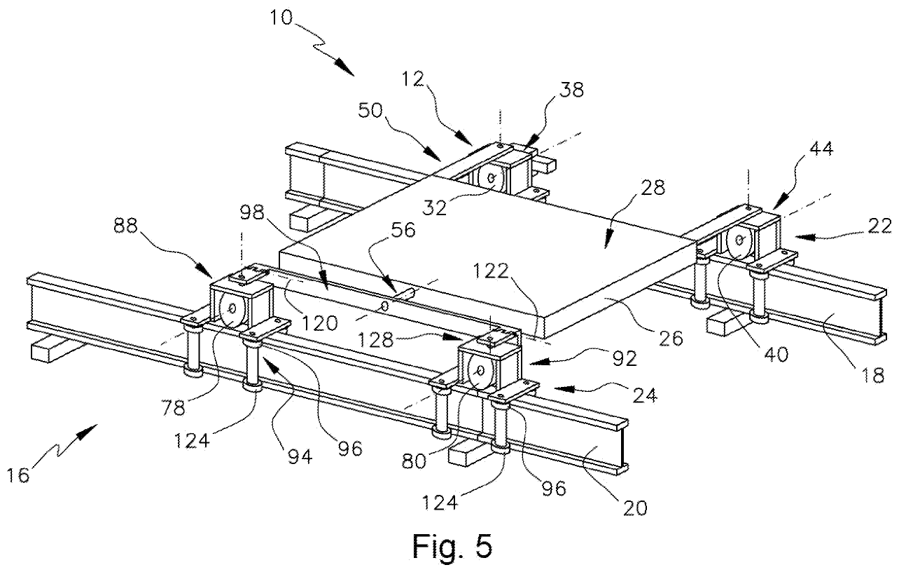

FIG. 5 shows an embodiment which takes this into account. There again, not all components are provided with reference signs. The support rollers 78 and 80 of the second chassis unit 24 can each be pivoted relative to the transport structure 26 by means of a pivoting device 118 about a pivot axis 120 and 122, respectively, which extends in a vertical plane parallel to the main axis 14 and a plane parallel to the transport plane 28. For this purpose, the support units 88 and 92 of the second chassis unit 24 are mounted accordingly.

When the second chassis unit 24 is now lowered in a decline section, there is no more torsion at the pivot axes 120, 122, which is gentle on the material overall.

Due to the now additional degree of freedom, however, supplementary measures must be taken to prevent the support units 88 and 90 of the second chassis unit 24 from tilting to the side. In the present embodiment, this is achieved by the respective support system 94 engaging further around the second rail 20 and also engaging at the bottom of the rail 20 with further support rollers 124.

A corresponding pivoting capability with respect to the transport structure 26 can also be provided in the first chassis unit 22, with the support system 46 there being adapted accordingly in order to prevent the first chassis unit 22 from tilting laterally there as well.

A corresponding pivoting device 118 may also be provided in the embodiment according to FIG. 2 and implemented there in the first chassis unit 22 and/or the second chassis unit 24. In this context, FIG. 2 illustrates only a pivot axis 126 on the bearing structure 66.

With the transport carriage 10, in which the two chassis units 22, 24 each have two load-bearing rollers 32 and 40 and 78 and 80, respectively, an even distribution of force to all four rollers 32, 40, 78 and 80 is possible, whereby a determinable generation of force on the first rail 18 is realized at the drive roller 32. This generally allows upward travel up to a gradient of about 1.5°.

In all embodiments, a dampening system 128 may be provided that dampens the rotation or the pivoting of the components relative to one another at the tilt axis 58 and/or at the pivot axes 110, 112 of the bearing swing arms 106, 108 and/or at the pivot axes 120, 122 of the pivoting device 118. For this purpose, for example, compression springs, torsion springs, rubber buffers or the like can be provided as damping elements.

While this invention is susceptible to embodiments in many different forms, there is described in detail herein, preferred embodiments of the invention with the understanding that the present disclosures are to be considered as exemplifications of the principles of the invention and are not intended to limit the broad aspects of the invention to the embodiments illustrated.

1. A transport carriage for transporting objects comprising:
a) a chassis which defines a main axis of the transport carriage and is configured to run on a rail system having a first rail and a second rail parallel thereto, and comprises a first chassis unit for the first rail and a second chassis unit for the second rail;
b) a transport structure for at least one object, the transport structure defining a transport plane;
wherein
c) the first chassis unit is coupled to the transport structure in a rotationally fixed manner such that the first chassis unit cannot be tilted relative to the transport plane in the direction of the main axis;
e) the second chassis unit is coupled to the transport structure in a rotatable manner such that the second chassis unit can be tilted relative to the transport plane in the direction of the main axis about a tilt axis.

2. The transport carriage according to claim 1, wherein the tilt axis extends parallel to the support plane and perpendicular to the main axis.

3. The transport carriage according to claim 1, wherein the second chassis unit is configured as a mono-roller chassis unit with a single load-bearing individual support roller, wherein
a) the individual support roller has an axis of rotation which extends coaxially with the tilt axis;
and/or
b) the individual support roller is supported by a bearing frame.

4. The transport carriage according to claim 3, wherein the individual support roller is rotatable about a steering axis.

5. The transport carriage according to claim 1, wherein the second chassis unit is configured as a multi-roller chassis unit with at least a first load-bearing support roller and a second load-bearing support roller.

6. The transport carriage according to claim 5, wherein, viewed in the direction of the main axis, the first support roller is arranged leading in front of the tilt axis and the second support roller is arranged trailing behind the tilt axis.

7. The transport carriage according to claim 6, wherein the first support roller is mounted in or on a first support unit and the second support roller is mounted in or on a second support unit, which are connected to one another by a connecting structure, which in turn is connected to the bearing structure such that it can tilt about the tilting axis.

8. The transport carriage according to claim 7, further comprising a compensating device which enables displacement of at least one load-bearing support roller in the direction transverse to the main axis.

9. The transport carriage according to claim 8, wherein the compensating device has at least one bearing swing arm on at least one chassis unit, wherein the bearing swing arm is mounted such that the bearing swing arm is pivotal about a swinging axis and carries a support unit for a support roller.

10. The transport carriage according to claim 9, wherein the compensating device comprises a first bearing swing arm for the first support unit of the second chassis unit and a second bearing swing arm for the second support unit of the second chassis unit.

11. The transport carriage according to one claim 1, further comprising a pivoting device by means of which any support rollers provided on the first chassis unit and/or any support rollers provided on the second chassis unit can each be pivoted relative to the transport structure about a pivot axis which extends in a vertical plane parallel to the main axis and a plane parallel to the transport plane.

12. The transport carriage according to claim 1, wherein the transport carriage comprises a dampening system by means of which a rotation or a pivoting of components relative to each other on one or more of the tilt axis, the swinging axes and the pivot axes, if the respective axis is provided, dampens.

13. A transport system for transporting objects, comprising: a rail system with a first rail and a second rail parallel thereto, and a plurality of transport carriages which travel on the rail system,
wherein
the transport carriages are configured according to claim 1.

14. The transport carriage according to claim 1, further comprising a compensating device which enables displacement of at least one load-bearing support roller in the direction transverse to the main axis.

15. The transport carriage according to claim 14, wherein the compensating device has at least one bearing swing arm on at least one chassis unit, wherein the bearing swing arm is mounted such that the bearing swing arm is pivotal about a swinging axis and carries a support unit for a support roller.
